(19) United States
(12) Patent Application Publication
(10) Pub. No.: US 2026/0225381 A1
(43) Pub. Date: Aug. 6, 2026

(54) DRYING DEVICE AND RECORDING DEVICE

(71) Applicant: SEIKO EPSON CORPORATION, Tokyo (JP)

(72) Inventor: Tadashi AIZAWA, MATSUMOTO-SHI (JP)

(21) Appl. No.: 19/460,569

(22) Filed: Jan. 27, 2026

(30) Foreign Application Priority Data
Jan. 30, 2025 (JP) 2025-013729

(51) Int. Cl. B41J 11/00; B41J 29/377

(52) U.S. Cl. CPC B41J 11/0024; B41J 11/00216; B41J 29/377

(57) ABSTRACT

A drying device includes a conveyance section configured to convey a medium onto which liquid has been ejected, a first heating section configured to heat the medium conveyed by the conveyance section, and a second heating section provided further upstream in a conveyance direction of the medium than the first heating section and configured to heat the medium conveyed by the conveyance section. The first heating section heats the medium with an infrared ray or a heating wire. The second heating section includes a first electrode, a second electrode disposed to surround the first electrode in plan view from a first direction facing the medium, a first conductor including a coil and configured to electrically couple a transmission line capable of transmitting a high-frequency voltage and the first electrode, and a second conductor configured to electrically couple the transmission line and the second electrode.

The present application is based on, and claims priority from JP Application Serial Number 2025-013729, filed January 30, 2025, the disclosure of which is hereby incorporated by reference herein in its entirety.

### BACKGROUND

### 1. Technical Field

The present disclosure relates to a drying device and a recording device.

### 2. Related Art

For example, JP-A-2019-155811 discloses an image forming apparatus including a drying device that dries a medium onto which liquid is ejected. In order to improve the drying efficiency, the drying device explained above includes a plurality of AC electric field generation sections that dry the medium by generating electromagnetic waves toward the medium onto which the liquid has been ejected. The AC electric field generation section explained above is an example of an electromagnetic wave generation section and generates electromagnetic waves toward the medium by supplying a high-frequency voltage between a first electrode and a second electrode. Accordingly, it is possible to dry the medium onto which the liquid has been ejected.

JP-A-2019-155811 is an example of the related art.

However, in the drying device explained above, thermal denaturation on the medium is likely to occur. Therefore, it is desired to dry the medium while maintaining the quality of the medium.

### SUMMARY

According to an aspect of the present disclosure, there is provided a drying device including: a conveyance section configured to convey a medium onto which liquid is ejected; a first heating section configured to heat the medium conveyed by the conveyance section; and a second heating section provided further upstream in a conveyance direction of the medium than the first heating section and configured to heat the medium conveyed by the conveyance section, wherein the first heating section heats the medium with an infrared ray or a heating wire, and the second heating section includes: a first electrode; a second electrode disposed to surround the first electrode in plan view from a first direction toward the medium; a first conductor including a coil and configured to electrically couple a transmission line capable of transmitting a high-frequency voltage and the first electrode; and a second conductor configured to electrically couple the transmission line and the second electrode.

According to an aspect of the present disclosure, there is provided a recording device including: a recording section configured to perform recording by ejecting liquid onto a medium; a conveyance section configured to convey the medium onto which the liquid is ejected by the recording section; a first heating section configured to heat the medium conveyed by the conveyance section; and a second heating section provided further upstream in a conveyance direction of the medium than the first heating section and configured to heat the medium conveyed by the conveyance section, wherein the first heating section heats the medium with an infrared ray or a heating wire, and the second heating section includes: a first electrode; a second electrode disposed to surround the first electrode in plan view from a first direction facing the medium; a first conductor including a coil and configured to electrically couple a transmission line capable of transmitting a high-frequency voltage and the first electrode; and a second conductor configured to electrically couple the transmission line and the second electrode.

### BRIEF DESCRIPTION OF THE DRAWINGS

FIG. 1 is a schematic diagram illustrating a recording system in a first embodiment.

FIG. 2 is a schematic diagram illustrating a drying unit in the first embodiment.

FIG. 3 is a perspective view illustrating a second heating section in the first embodiment.

FIG. 4 is a schematic diagram illustrating the drying unit in the first embodiment.

FIG. 5 is a schematic diagram illustrating a drying unit in a second embodiment.

FIG. 6 is a schematic diagram illustrating a drying unit in a third embodiment.

FIG. 7 is a schematic diagram illustrating a drying unit in a fourth embodiment.

### DESCRIPTION OF EMBODIMENTS

### First Embodiment

Hereinafter, a drying device and a recording system including a recording device according to an embodiment are explained. In the following explanation, a direction intersecting a vertical direction Z is represented as a width direction X and a direction intersecting the vertical direction Z and the width direction X is represented as an intersecting direction Y. One direction in the width direction X is represented as a first width direction X1 and the other direction in the width direction X is represented as a second width direction X2. One direction in the intersecting direction Y is represented as a first intersecting direction Y1 and the other direction in the intersecting direction Y is represented as a second intersecting direction Y2. An upward direction in the vertical direction Z is represented as an upward direction Z1 and a downward direction in the vertical direction Z is represented as a downward direction Z2. The upward direction Z1 is equivalent to an example of a first direction. Plan view from the upward direction Z1 is simply referred to as plan view.

### Configuration of a recording system 10

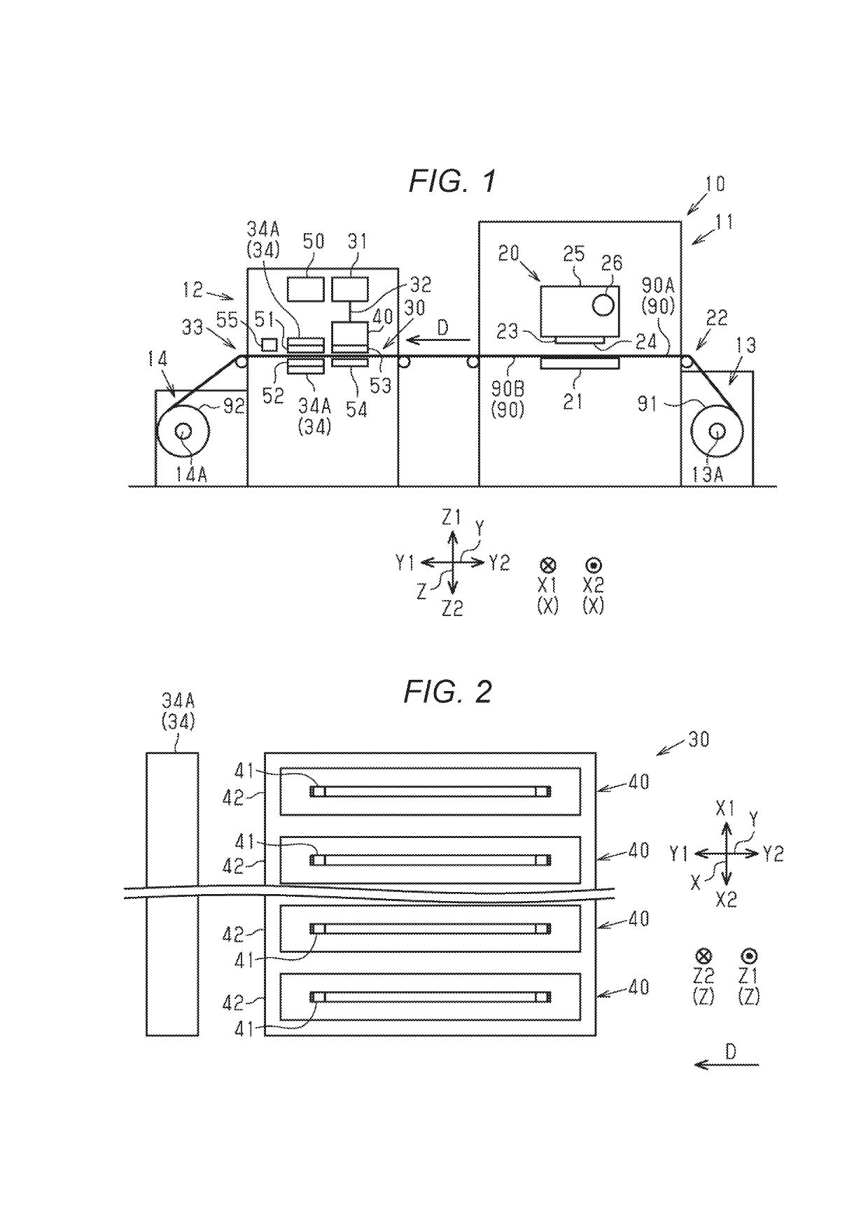

As illustrated in FIG. 1, a recording system 10 is a system that performs recording on a medium 90. In particular, the recording system 10 is a system that performs recording on the medium 90 by ejecting liquid onto the medium 90. The recording system 10 is a system that dries the medium 90 after the recording onto which the liquid has been ejected. The medium 90 is fabric but may be, for example, paper.

The recording system 10 includes a recording device 11. The recording device 11 is configured to perform recording on the medium 90. In particular, the recording device 11 performs recording on the medium 90 by ejecting liquid onto the medium 90. The recording device 11 may be an inkjet printer that performs recording by ejecting ink, which is an example of the liquid, onto the medium 90.

The liquid may be pigment ink. The pigment ink contains pigment, water, and a solvent. The solvent may contain, for example, glycerin. Glycerin is a solvent for preventing clogging in a nozzle that ejects the liquid. Vaporization of glycerin improves the wear resistance of the medium 90 onto which the pigment ink has been ejected. The pigment ink may be either colored or colorless.

The recording system 10 includes a drying device 12. The drying device 12 is configured to dry the medium 90 after the recording onto which the recording device 11 has ejected the liquid. In particular, the drying device 12 dries the medium 90 after the recording by generating electromagnetic waves.

The recording system 10 includes a feeding section 13. The feeding section 13 lets out the medium 90 before recording to the recording device 11. The feeding section 13 includes a feeding roller 13A. The feeding roller 13A extends in the width direction X. In the width direction X, the width of the feeding roller 13A is larger than the width of the medium 90. The feeding roller 13A is configured to rotatably hold a first roll body 91. The first roll body 91 is the medium 90 before recording that is rolled up. The medium 90 may be long. As explained above, the feeding roller 13A holds the medium 90 to be let out to the recording device 11.

The recording system 10 includes a winding section 14. The winding section 14 winds the medium 90 after the recording on which the recording has been performed by the recording device 11. In particular, the winding section 14 winds the medium 90 after the recording dried by the drying device 12. The winding section 14 includes a winding roller 14A. The winding roller 14A extends in the width direction X. In the width direction X, the width of the winding roller 14A is larger than the width of the medium 90. The winding roller 14A is configured to rotatably hold a second roll body 92. The second roll body 92 is the medium 90 after the recording that is rolled up. As explained above, the winding roller 14A winds the medium 90 on which the recording has been performed by the recording device 11 and that has been dried by the drying device 12.

### Configuration of the recording device 11

The recording device 11 includes a recording section 20, a recording support section 21, and a recording conveyance section 22. The recording section 20 is configured to record an image on the medium 90 by ejecting liquid onto the medium 90. The recording section 20 ejects the liquid onto a front surface 90A of the medium 90. The recording section 20 performs recording on the medium 90 supported by the recording support section 21. The recording section 20 performs recording on the medium 90 conveyed by the recording conveyance section 22.

The recording section 20 includes a head 23. The head 23 may be a serial head or may be a line head. The serial head is a head that performs scanning in the width direction X of the medium 90. The line head is a head that simultaneously performs recording over the width direction X of the medium 90.

The head 23 includes a nozzle surface 24 in which a not-illustrated plurality of nozzles are opened. The nozzle surface 24 is a surface facing the downward direction Z2. The nozzle surface 24 is a surface facing the front surface 90A of the medium 90 conveyed by the recording conveyance section 22. Each of the plurality of nozzles is configured to open in the downward direction Z2. Each of the plurality of nozzles is configured to eject liquid.

The recording section 20 may include a carriage 25 and a carriage support section 26. The carriage 25 is configured to support the head 23. The carriage support section 26 extends in the width direction X. The carriage support section 26 supports the carriage 25 to be movable along the width direction X. The carriage 25 is movable in the width direction X along the carriage support section 26 with a driving force from a not-illustrated driving source.

The recording support section 21 is configured to support the medium 90 conveyed by the recording conveyance section 22. The recording support section 21 is located in the downward direction Z2 of the recording section 20. The recording support section 21 supports a rear surface 90B of the medium 90 conveyed by the recording conveyance section 22. The recording support section 21 is located in the downward direction Z2 of the head 23.

The recording conveyance section 22 is configured to convey the medium 90 in a conveyance direction D. The conveyance direction D is a direction in the intersecting direction Y. The recording conveyance section 22 may include a plurality of rollers. The recording conveyance section 22 conveys the medium 90 in the conveyance direction D using the plurality of rollers but may convey the medium 90 in the conveyance direction D using a conveyor belt driven by the plurality of rollers. The recording conveyance section 22 may perform intermittent conveyance in which conveyance and stop of the medium 90 are repeated.

### Configuration of the drying device 12

The drying device 12 includes a drying unit 30. The drying unit 30 is configured to dry the medium 90 after recording. That is, the drying device 12 sets, as a target object to be dried, the medium 90 on which recording has been performed by the recording section 20.

The drying unit 30 is configured to dry the medium 90 after the recording by generating electromagnetic waves. The drying unit 30 is located in the upward direction Z1 and the downward direction Z2 of the medium 90 but may be located in the upward direction Z1 of the medium 90 or may be located in the downward direction Z2 of the medium 90.

The drying device 12 includes a high-frequency voltage generation section 31. The drying device 12 may include a plurality of high-frequency voltage generation sections 31. The high-frequency voltage generation section 31 is configured to generate a high-frequency voltage. The high-frequency voltage generation section 31 supplies the high-frequency voltage to the drying unit 30 via a transmission line 32.

The transmission line 32 is a line that connects the drying unit 30 and the high-frequency voltage generation section 31. The transmission line 32 is capable of transmitting, to the drying unit 30, the high-frequency voltage supplied from the high-frequency voltage generation section 31. That is, the transmission line 32 is capable of transmitting a high-frequency voltage.

The transmission line 32 may be a coaxial cable but is not limited to the coaxial cable. The transmission line 32 may include a first line and a second line. The first line may be a core wire of the transmission line 32. The second line may be an electromagnetic shield that covers the first line.

The drying device 12 includes a drying conveyance section 33. The drying conveyance section 33 is configured to convey the medium 90 in the conveyance direction D. The drying conveyance section 33 is an example of a conveyance section. The conveyance direction D is a direction in the intersecting direction Y. The drying conveyance section 33 may convey the medium 90 in the conveyance direction D using a plurality of rollers. The drying conveyance section 33 may perform continuous conveyance for continuously conveying the medium 90. Slack of the medium 90 may occur between the recording conveyance section 22 and the drying conveyance section 33.

The drying device 12 includes a control section 50. The control section 50 controls the drying device 12. Specifically, the control section 50 controls the drying unit 30. The control section 50 controls the high-frequency voltage generation section 31. The control section 50 controls the drying conveyance section 33.

The control section 50 may include one or more processors that execute various kinds of processing according to a computer program. The control section 50 may include one or more dedicated hardware circuits. The control section 50 may include an application specific integrated circuit that executes at least some of the various kinds of processing. The control section 50 may include a circuit including a combination of a processor and a hardware circuit. The processor includes a CPU and memories such as RAM and ROM. The memories store program codes or commands configured to cause the CPU to execute processing. The memories, that is, computer readable media include all readable media that can be accessed by a general-purpose or dedicated computer.

The drying unit 30 includes a first heating section 34 and a second heating section 40. The first heating section 34 heats the medium 90 onto which the liquid has been ejected by the recording section 20. The first heating section 34 heats the medium 90 conveyed by the drying conveyance section 33.

The first heating section 34 is configured to heat the medium 90 with an infrared ray. The first heating section 34 may be a heating wire heater 34A including a heating wire. The first heating section 34 is a heat conduction type. The first heating section 34 is located in both of the upward direction Z1 and the downward direction Z2 of the medium 90 but is not limited thereto.

The first heating section 34 heats the medium 90 from both of the front surface 90A and the rear surface 90B, thereby drying the medium 90. Specifically, the first heating section 34 heats, from both of the front surface 90A and the rear surface 90B, the liquid ejected onto the medium 90.

The second heating section 40 heats the medium 90 onto which the liquid has been ejected by the recording section 20. The second heating section 40 heats the medium 90 conveyed by the drying conveyance section 33. The second heating section 40 is provided further upstream in the conveyance direction D than the first heating section 34. That is, the first heating section 34 heats the medium 90 dried by the second heating section 40. The first heating section 34 and the second heating section 40 are provided to be separated in the conveyance direction D.

The second heating section 40 is configured to generate electromagnetic waves according to application of a high-frequency voltage. The second heating section 40 is an example of an electromagnetic wave generation section. The second heating section 40 is located in the upward direction Z1 of the medium 90 but is not limited thereto.

The second heating section 40 heats the medium 90 from the front surface 90A , thereby drying the medium 90. Specifically, the second heating section 40 heats, from the front surface 90A, the liquid ejected onto the medium 90.

The second heating section 40 dries the medium 90 by vaporizing the liquid ejected onto the medium 90. That is, the second heating section 40 is a type of drying the medium 90 regardless of whether water vapor is saturated around the medium 90. For this reason, the second heating section 40 does not need to blow dry gas in which water vapor is not saturated around the medium 90.

The second heating section 40 generates an AC electric field by generating the electromagnetic waves. The electromagnetic waves generated by the second heating section 40 have an electric field as a main component. The second heating section 40 can significantly reduce induction of a magnetic field by a generated electric field as compared with a heating section that generates normal electromagnetic waves.

As a specific example, the second heating section 40 generates electromagnetic waves of 2.4 GHz but is not limited thereto. The second heating section 40 may generate, for example, electromagnetic waves of 3 MHz to 300 MHz. The second heating section 40 may generate, for example, electromagnetic waves of 300 MHz to 30 GHz and may generate, above all, electromagnetic waves of 10 MHz to 20 GHz.

The drying unit 30 includes a first contact section 51 and a second contact section 52. That is, the drying device 12 includes the first contact section 51 and the second contact section 52. The first contact section 51 is disposed to face the front surface 90A of the medium 90. The first contact section 51 is provided between the first heating section 34 located further in the upward direction Z1 than the medium 90 and the medium 90. The first contact section 51 may have a flat plate shape. The first contact section 51 is capable of coming into contact with the medium 90 between the first heating section 34 and the medium 90.

The second contact section 52 is disposed to face the rear surface 90B of the medium 90. The second contact section 52 is provided between the first heating section 34 located further in the downward direction Z2 than the medium 90 and the medium 90. The second contact section 52 is provided at a position where the medium 90 is sandwiched between the second contact section 52 and the first contact section 51. As explained above, the first contact section 51 and the second contact section 52 are provided to sandwich the medium 90. The second contact section 52 may have a flat plate shape. The second contact section 52 is capable of coming into contact with the medium 90 between the first heating section 34 and the medium 90.

The first contact section 51 and the second contact section 52 are made of a material that transfers the amount of heat generated by the first heating section 34. The first contact section 51 and the second contact section 52 may be made of a material having a high electrothermal property. The first contact section 51 and the second contact section 52 may be made of metal.

The drying unit 30 includes a third contact section 53 and a fourth contact section 54. That is, the drying device 12 includes the third contact section 53 and the fourth contact section 54. The third contact section 53 is disposed to face the front surface 90A of the medium 90. The third contact section 53 is provided between the second heating section 40 and the medium 90. The third contact section 53 may have a flat plate shape. The third contact section 53 is capable of coming into contact with the medium 90 between the second heating section 40 and the medium 90. The third contact section 53 protects a first electrode 41 and a second electrode 42 explained below.

The fourth contact section 54 is disposed to face the rear surface 90B of the medium 90. The fourth contact section 54 may have a flat plate shape. The fourth contact section 54 is capable of coming into contact with the medium 90. The fourth contact section 54 is capable of supporting the medium 90. The fourth contact section 54 is configured to sandwich the medium 90 between the fourth contact section 54 and the third contact section 53. As explained above, the third contact section 53 and the fourth contact section 54 are provided to sandwich the medium 90.

The third contact section 53 and the fourth contact section 54 are made of a material that transmits electromagnetic waves generated by the second heating section 40. The third contact section 53 and the fourth contact section 54 are made of a member having insulation. The third contact section 53 and the fourth contact section 54 may be glass plates. The third contact section 53 and the fourth contact section 54 may be ceramic having high transmittance. The third contact section 53 and the fourth contact section 54 may be made of resin having a low dielectric loss tangent. The third contact section 53 and the fourth contact section 54 may be made of polypropylene. The third contact section 53 and the fourth contact section 54 may be made of polyethylene.

The first contact section 51 and the third contact section 53 are provided to be separated in the conveyance direction D. Accordingly, heat transfer between the first contact section 51 and the third contact section 53 can be suppressed.

The second contact section 52 and the fourth contact section 54 are provided to be separated in the conveyance direction D. Accordingly, heat transfer between the second contact section 52 and the fourth contact section 54 can be suppressed.

The drying unit 30 includes a temperature detection section 55. The temperature detection section 55 is configured to detect the temperatures of the first contact section 51 and the second contact section 52. The temperature detection section 55 may detect the temperature of at least one of the first contact section 51 and the second contact section 52.

### Disposition of the first heating section 34 and the second heating section 40

As illustrated in FIG. 2, the drying unit 30 may include one first heating section 34. The drying unit 30 may include a plurality of second heating sections 40.

The plurality of second heating sections 40 are disposed side by side in the width direction X. The plurality of second heating sections 40 may be integrally configured to share a second electrode 42 explained below. The second electrode 42 in the plurality of second heating sections 40 may be shared at positions adjacent to one another in the width direction X. The plurality of second heating sections 40 are provided further upstream in the conveyance direction D than the plurality of first heating sections 34.

### Configuration of the second heating section 40

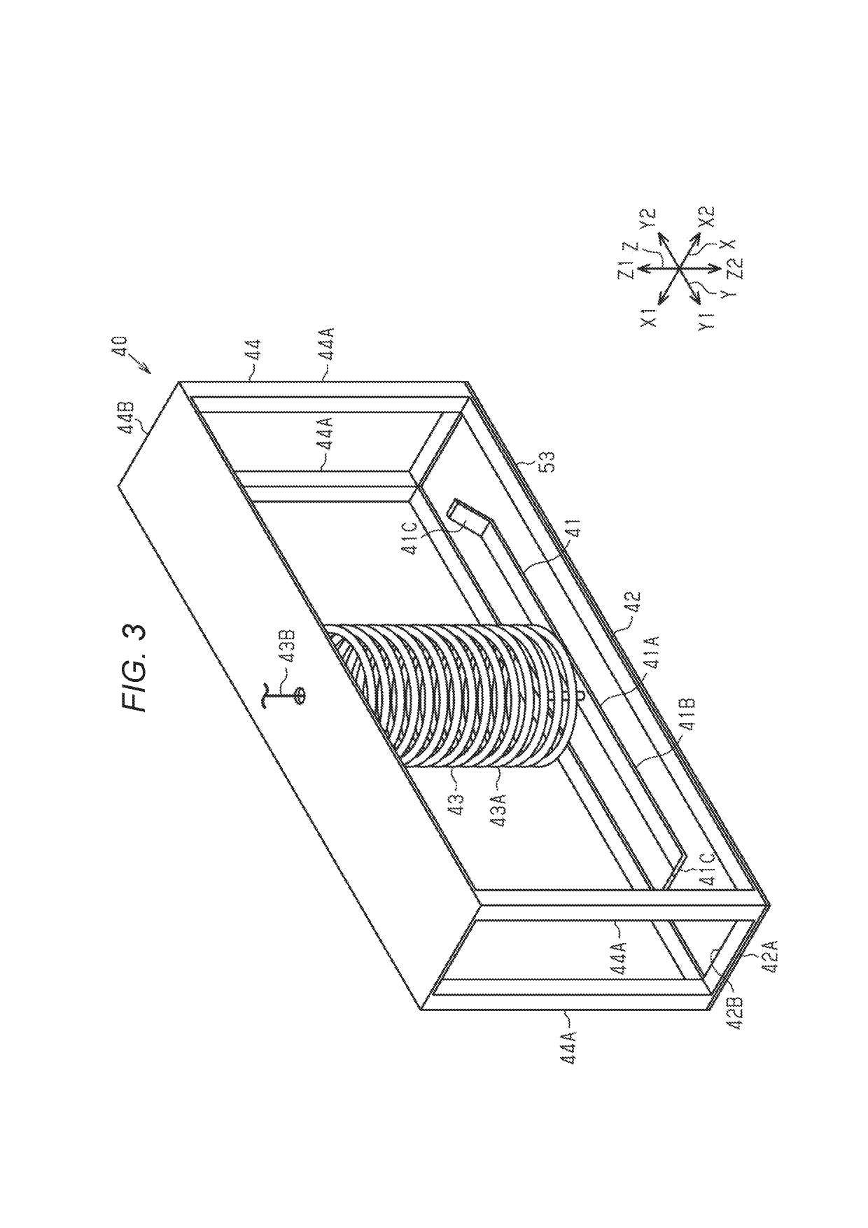

Here, a configuration of the second heating section 40 is explained in detail with reference to FIG. 3. Hereinafter, one second heating section 40 is representatively explained.

As illustrated in FIG. 3, the second heating section 40 includes a first electrode 41, a second electrode 42, a first conductor 43, and a second conductor 44. FIG. 3 is a diagram in which the first electrode 41 and the second electrode 42 are disposed on the upward direction Z1 side of the medium 90.

The first electrode 41 has a flat plate shape but may have a bar shape. The first electrode 41 is longitudinal in the width direction X in plan view. That is, the first electrode 41 extends in the width direction X in plan view. The first electrode 41 may have a rectangular shape in plan view.

The first electrode 41 includes a first electrode surface 41A. The first electrode surface 41A is a surface facing the downward direction Z2. That is, the first electrode surface 41A is a surface facing the front surface 90A of the medium 90. The first electrode 41 may be disposed such that the first electrode surface 41A is in contact with the third contact section 53.

The first electrode 41 includes a central portion 41B and both end portions 41C. The central portion 41B is a part located at the center in the width direction X. Both the end portions 41C are parts located at both ends in the width direction X. The central portion 41B and both the end portions 41C are integrally provided.

The central portion 41B configures the first electrode surface 41A. The central portion 41B is provided at a position overlapping the second electrode 42 in the vertical direction Z. That is, at least a part of the first electrode 41 is provided at the position overlapping the second electrode 42 in the vertical direction Z.

Both the end portions 41C are configured to be inclined upward with respect to the outer side in the width direction X. Both the end portions 41C are located to be separated from the third contact section 53. That is, both the end portions 41C are extended in the upward direction Z1 separating from the medium 90 in the vertical direction Z. Both the end portions 41C may be curved to separate from the third contact section 53.

The second electrode 42 has a flat plate shape. The second electrode 42 includes a second electrode surface 42A. The second electrode surface 42A is a surface facing the downward direction Z2. That is, the second electrode surface 42A is a surface facing the front surface 90A of the medium 90. The second electrode 42 may be disposed such that the second electrode surface 42A is in contact with the third contact section 53.

The second electrode 42 includes an opening section 42B. The opening section 42B has a rectangular shape in plan view but may have a rounded rectangular shape. The first electrode 41 is located in the opening section 42B in plan view. The opening section 42B surrounds the first electrode 41 in plan view. That is, the second electrode 42 is disposed to surround the first electrode 41 in plan view.

The first conductor 43 is configured to electrically couple the transmission line 32 and the first electrode 41. The first conductor 43 includes a coil 43A. The coil 43A extends in the vertical direction Z. One end of the coil 43A is coupled to the first electrode 41. The other end of the coil 43A is coupled to a conductive wire 43B. The conductive wire 43B is coupled to the transmission line 32.

The second conductor 44 is configured to electrically couple the transmission line 32 and the second electrode 42. The second conductor 44 may include a pillar 44A. The second conductor 44 may include a plurality of pillars 44A. The pillar 44A is electrically coupled to the second electrode 42. The pillar 44A extends in the upward direction Z1 from the second electrode 42. The pillar 44A is made of metal.

The second conductor 44 may include a top plate 44B. The top plate 44B is electrically coupled to the pillar 44A. The top plate 44B is provided at the upper end portion of the pillar 44A. The top plate 44B may be integrated with the pillar 44A. The top plate 44B is made of metal.

Since the second heating section 40 is configured as explained above, when a high-frequency voltage is applied, the first electrode 41 and the second electrode 42 generate electromagnetic waves according to the application of the high-frequency voltage to thereby heat the medium 90.

The second heating section 40 explained above can transmit large thermal energy to the medium 90 by generating the electromagnetic waves. The second heating section 40 may be an electromagnetic wave type rather than a heat conduction type and may not include a member such as a heating wire for heating. Accordingly, it is possible to achieve a reduction in the size of the second heating section 40.

A minimum separation distance between the first electrode 41 and the second electrode 42 is 1/10 or less of the wavelength of electromagnetic waves output from the second heating section 40. Accordingly, the electromagnetic waves generated when the high-frequency voltage is applied can be attenuated in the vicinity of the first electrode 41 and the second electrode 42. Accordingly, the intensity of the electromagnetic waves reaching the distance from the first electrode 41 and the second electrode 42 can be reduced. That is, the electromagnetic waves generated from the second heating section 40 is very strong in the vicinity of the first electrode 41 and the second electrode 42 and is very weak at the distance.

Since a frequency band of electromagnetic waves to be generated is appropriately controlled, the second heating section 40 explained above can intensively generate an AC electric field in the vicinity of the first electrode 41 and the second electrode 42. In other words, it is possible to suppress the influence on the surroundings involved in the generation of the electromagnetic waves beyond the vicinity of the first electrode 41 and the second electrode 42. For example, a range of 3 mm to 3 cm may be equivalent to the vicinity of the first electrode 41 and the second electrode 42.

### Drying Method by the Drying Device 12

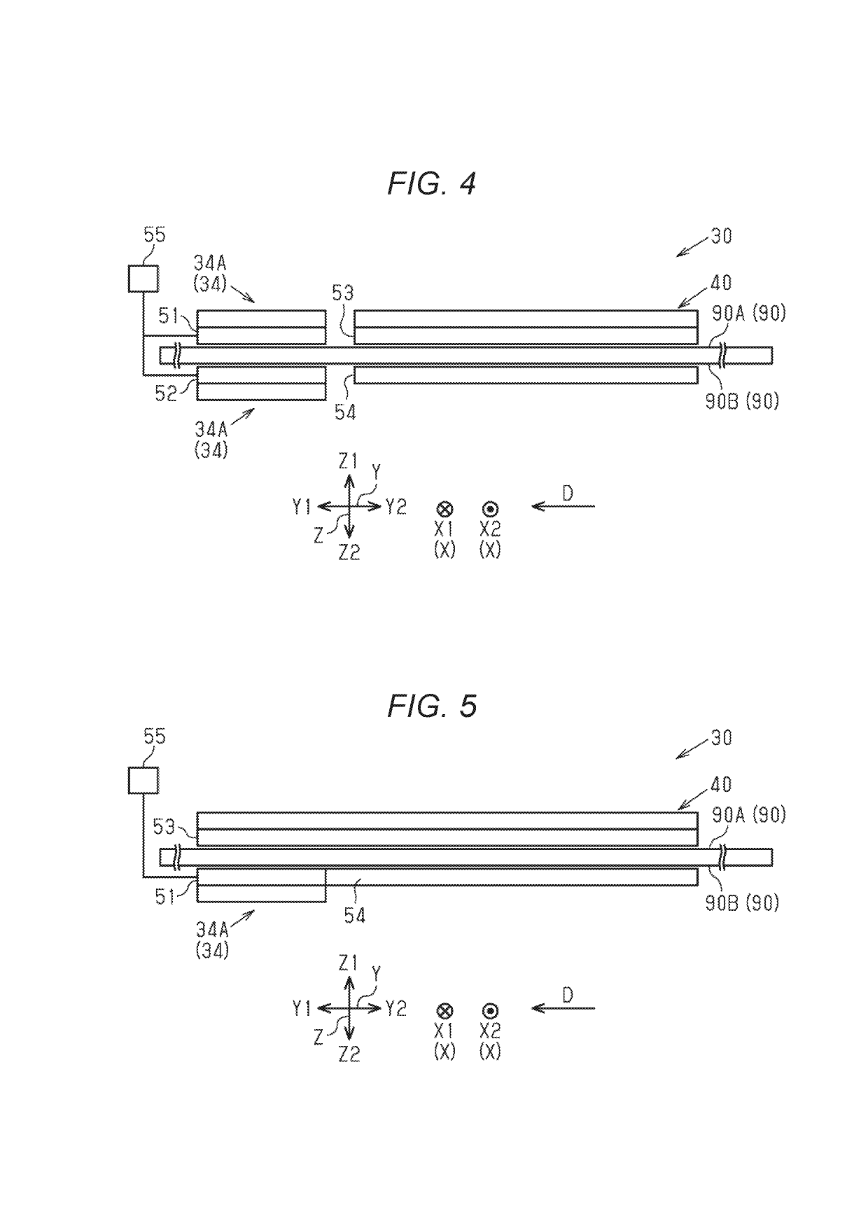

Next, a drying method by the drying device 12 is explained with reference to FIG. 4.

In the present embodiment, when the medium 90 is dried, temporary drying and main drying are performed by the drying device 12. The temporary drying is performed before the main drying. In the temporary drying, the medium 90 is dried by mainly vaporizing water contained in liquid ejected onto the medium 90.

As a specific example, a case in which the medium 90 onto which pigment ink has been ejected as liquid is dried is explained. In this case, in the temporary drying, water contained in the pigment ink is mainly vaporized at approximately 100°C. In the temporary drying, a solvent can also be vaporized other than the water. In the case explained above, it is desirable to rapidly raise the temperature of the pigment ink.

In the main drying, the solvent contained in the pigment ink is mainly vaporized at approximately 270°C to 300°C. The main drying can vaporize a larger amount of the solvent than the temporary drying. In the main drying, it is desirable to maintain the temperature of the pigment ink without excessively raising the temperature in order to increase the certainty of vaporization of glycerin without causing thermal denaturation on the medium 90. The main drying is preferably performed for a longer time than the temporary drying.

The first heating section 34 heats gas around the medium 90. The first heating section 34 vaporizes the liquid ejected onto the medium 90 by raising the temperature of the gas around the medium 90.

The second heating section 40 generates electromagnetic waves. The electromagnetic waves generated from the second heating section 40 do not heat the gas around the medium 90. For this reason, the electromagnetic waves do not directly heat the medium 90 itself and heat the pigment ink. The second heating section 40 directly vaporizes the pigment ink ejected onto the medium 90.

As explained above, although the generation itself of the electromagnetic wave does not directly cause thermal denaturation on the medium 90, the heat of the pigment ink is transferred to the medium 90 when the pigment ink is heated. Excessive transfer of the heat of the pigment ink to the medium 90 can cause thermal denaturation on the medium 90.

The second heating section 40 can raise the temperature of the liquid faster than the first heating section 34. On the other hand, it is not easier for the second heating section 40 to adjust the temperature of the medium 90 than for the first heating section 34.

As illustrated in FIG. 4, the second heating section 40 is disposed further upstream in the conveyance direction D than the first heating section 34. Accordingly, when the medium 90 is conveyed in the conveyance direction D, the medium 90 is heated by the first heating section 34 after being heated by the second heating section 40. The second heating section 40 mainly performs the temporary drying. The first heating section 34 mainly performs the main drying.

The control section 50 may control the first heating section 34 based on a detection result by the temperature detection section 55. When the temperatures of the first contact section 51 and the second contact section 52 are equal to or higher than a first threshold, the control section 50 may control, based on the detection result by the temperature detection section 55, the first heating section 34 to reduce an amount of heat to be output. When the temperatures of the first contact section 51 and the second contact section 52 are equal to or higher than the first threshold, the control section 50 may control, based on the detection result by the temperature detection section 55, the first heating section 34 to stop the output. The first threshold may be an upper limit value at which the medium 90 is not damaged. The first threshold may be approximately 300°C.

When the temperatures of the first contact section 51 and the second contact section 52 are equal to or lower than a second threshold, the control section 50 may control, based on the detection result by the temperature detection section 55, the first heating section 34 to increase the amount of heat to be output. The second threshold is smaller than the first threshold. The second threshold may be a lower limit value at which the main drying can be performed. The second threshold may be approximately 200°C.

### Action and effects of the first embodiment

Action and effects of the first embodiment are explained.

(1-1) The second heating section 40 is provided further upstream in the conveyance direction D than the first heating section 34. With this configuration, the speed of raising the temperature of the liquid ejected onto the medium 90 can be increased by the electromagnetic waves generated from the second heating section 40. In addition, after the temperature of the liquid ejected onto the medium 90 is raised, temperature adjustment for the medium 90 onto which the liquid has been ejected can be easily performed by heat from the first heating section 34. Accordingly, it is possible to suppress occurrence of thermal denaturation on the medium 90. Therefore, it is possible to dry the medium 90 while maintaining the quality of the medium 90.

(1-2) The liquid is pigment ink containing pigment, water, and a solvent. With this configuration, temporary drying of vaporizing the water from the liquid ejected onto the medium 90 can be performed by the second heating section 40. Accordingly, it is possible to increase, with electromagnetic waves generated from the second heating section 40, the speed of vaporizing the water from the liquid ejected onto the medium 90. In addition, main drying of vaporizing the solvent from the liquid ejected onto the medium 90 can be performed by the first heating section 34. As explained above, temperature adjustment for the medium 90 onto which the liquid has been ejected can be easily performed by heat from the first heating section 34. Accordingly, it is possible to suppress occurrence of thermal denaturation on the medium 90. Therefore, it is possible to dry the medium 90 while maintaining the quality of the medium 90.

(1-3) The drying device 12 includes the first contact section 51 provided between the first heating section 34 and the medium 90 and the second contact section 52 provided at a position where the medium 90 is sandwiched between the second contact section 52 and the first contact section 51. With this configuration, the medium 90 can be dried by the heat from the first heating section 34 in a state in which the medium 90 is in contact with the first contact section 51 and the second contact section 52 between the first contact section 51 and the second contact section 52. That is, the medium 90 can be dried in a state of being sandwiched by the first contact section 51 and the second contact section 52. Accordingly, it is possible to suppress shrinkage of the medium 90 involved in heating of the medium 90. For this reason, it is possible to suppress occurrence of thermal denaturation on the medium 90. Therefore, it is possible to dry the medium 90 while maintaining the quality of the medium 90.

(1-4) The drying device 12 includes the third contact section 53 provided between the second heating section 40 and the medium 90 and the fourth contact section 54 provided at a position where the medium 90 is sandwiched between the fourth contact section 54 and the third contact section 53. With this configuration, the medium 90 can be dried by electromagnetic waves from the second heating section 40 in a state in which the medium 90 is in contact with the third contact section 53 and the fourth contact section 54. When the liquid ejected onto the medium 90 is vaporized, vaporized moisture stays in the vicinity of the medium 90. Accordingly, it is possible to reduce a difference in a calorific value of the liquid due to a type of the medium 90 and a type of the liquid. In addition, since it is possible to improve the airtightness between the third contact section 53 and the fourth contact section 54 and the medium 90, it is possible to dry the medium 90 in an environment in which the liquid is less likely to oxidize. It is possible to suppress an imbalance in the distance between the medium 90 and the second heating section 40. It is possible to suppress shrinkage of the medium 90 involved in heating the medium 90. For this reason, it is possible to suppress occurrence of thermal denaturation on the medium 90. Therefore, it is possible to dry the medium 90 while maintaining the quality of the medium 90.

(1-5) The first heating section 34 is controlled based on a detection results of the temperatures of the first contact section 51 and the second contact section 52. With this configuration, the first heating section 34 can be controlled according to the temperatures of the first contact section 51 and the second contact section 52. For this reason, after the temperature of the liquid ejected onto the medium 90 is raised, temperature adjustment for the medium 90 onto which the liquid is ejected can be easily performed by heat from the first heating section 34. Accordingly, it is possible to suppress occurrence of thermal denaturation on the medium 90. Therefore, it is possible to dry the medium 90 while maintaining the quality of the medium 90.

(1-6) The first heating section 34 and the second heating section 40 are provided to be separated in the conveyance direction D. With this configuration, influence between the first heating section 34 and the second heating section 40 can be reduced. Accordingly, it is possible to perform heating by the first heating section 34 and heating by the second heating section 40 as intended.

### Second Embodiment

Next, a second embodiment is explained. In the following explanation, redundant explanation is omitted or simplified for the same components as the components in the embodiment explained above, and components different from the components in the embodiment explained above are explained.

As illustrated in FIG. 5, in the second embodiment, a heating region by the first heating section 34 and a heating region by the second heating section 40 may overlap on the downstream side in the conveyance direction D. That is, the heating region by the first heating section 34 and the heating region by the second heating section 40 in the conveyance direction D may partially overlap.

The first heating section 34 is provided in the downward direction Z2 of the medium 90. The first contact section 51 is provided between the first heating section 34 and the medium 90. The first contact section 51 may be made of a material having a higher thermal conductivity than the third contact section 53 and the fourth contact section 54. The first contact section 51 contains ceramic. The drying unit 30 may not include the second contact section 52.

The second heating section 40 extends to a position where the medium 90 is sandwiched between the second heating section and the first heating section 34 in the intersecting direction Y. The second heating section 40 extends to a position where the medium 90 is sandwiched between the second heating section 40 and the first contact section 51 in the intersecting direction Y. That is, the first contact section 51 is also heated by the first heating section 34 and is also heated by the second heating section 40.

The third contact section 53 extends to a position where the medium 90 is sandwiched between the third contact section 53 and the first contact section 51 in the intersecting direction Y. The first contact section 51 and the fourth contact section 54 are provided to be in contact in the conveyance direction D but may be provided to be separated in the conveyance direction D.

### Action and effects of the second embodiment

Action and effects of the second embodiment are explained.

(2-1) The heating region by the first heating section 34 and the heating region by the second heating section 40 partially overlap. The first contact section 51 is heated by the second heating section 40. With this configuration, the temperature of the medium 90 can be sufficiently raised by heating the medium 90 from both of the first heating section 34 and the second heating section 40. Therefore, it is possible to improve the drying efficiency of the medium 90.

(2-2) The first contact section 51 contains ceramic. With this configuration, by using a material having a high thermal conductivity for the first contact section 51, it is easy to maintain temperature for the medium 90 by the first heating section 34 and the second heating section 40. Accordingly, it is possible to suppress occurrence of thermal denaturation on the medium 90. Therefore, it is possible to dry the medium 90 while maintaining the quality of the medium 90.

### Third Embodiment

Next, a third embodiment is explained.

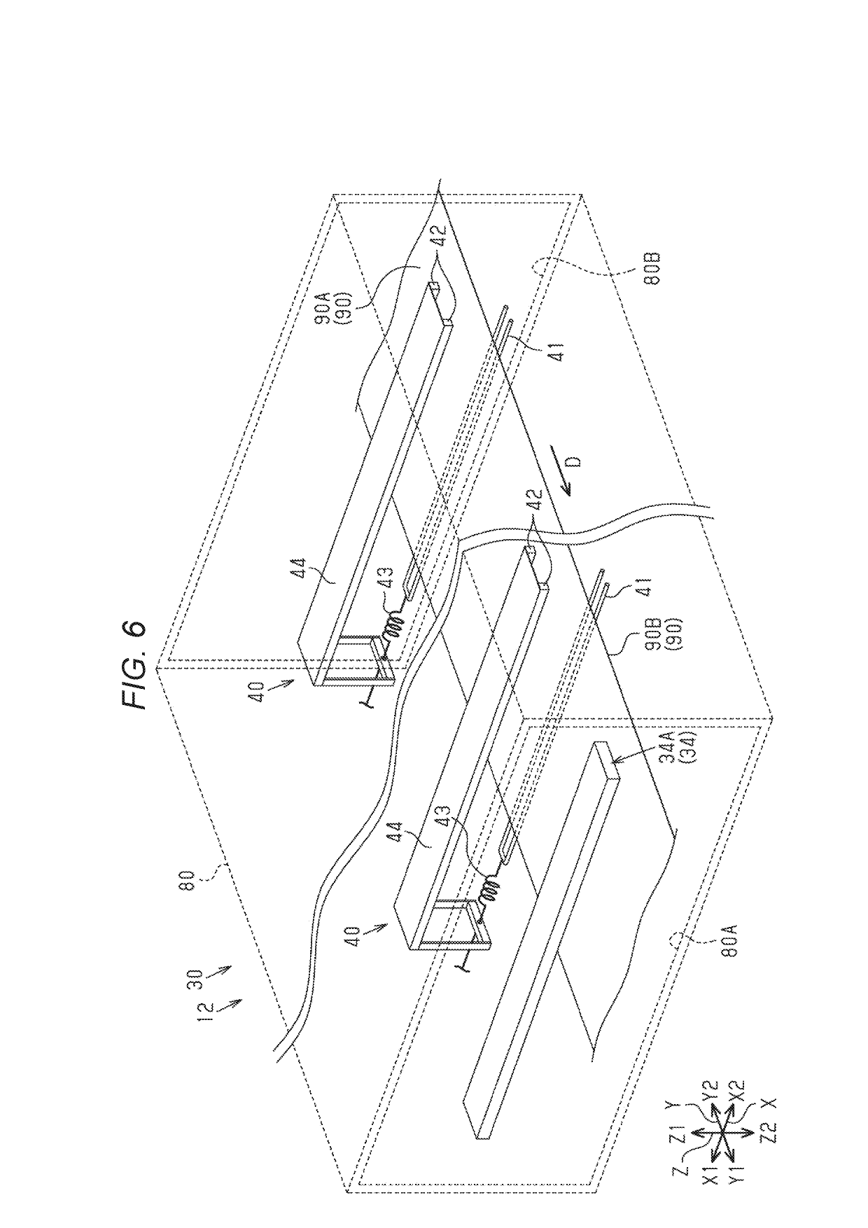

As illustrated in FIG. 6, in the third embodiment, the drying unit 30 may include a conductor housing 80. In FIG. 6, the conductor housing 80 is indicated by a broken line.

The conductor housing 80 may be provided on the inside of a housing of the drying device 12. The conductor housing 80 has conductivity. The conductor housing 80 is configured to house the first heating section 34 and the second heating section 40. The conductor housing 80 may be configured to house a plurality of first heating sections 34 and a plurality of second heating sections 40. The conductor housing 80 has a tubular shape conforming to a conveyance path of the medium 90. The conductor housing 80 may be provided such that the conveyance direction D is longitudinal.

The conductor housing 80 includes a discharge port 80A. The discharge port 80A is provided in the first intersecting direction Y1 of the conductor housing 80. The discharge port 80A is provided in order to discharge the medium 90 from the inside to the outside of the conductor housing 80. The conductor housing 80 includes a carry-in port 80B. The carry-in port 80B is provided in the second intersecting direction Y2 of the conductor housing 80. The carry-in port 80B is provided in order to convey the medium 90 from the outside to the inside of the conductor housing 80.

The conductor housing 80 may be electrically coupled to the second electrode 42. The conductor housing 80 may be grounded. Accordingly, the conductor housing 80 functions in the same manner as the second electrode 42. As explained above, the second heating section 40 may generate electromagnetic waves with the first electrode 41 and the second electrode 42 and the conductor housing 80.

### Fourth Embodiment

Next, a fourth embodiment is explained.

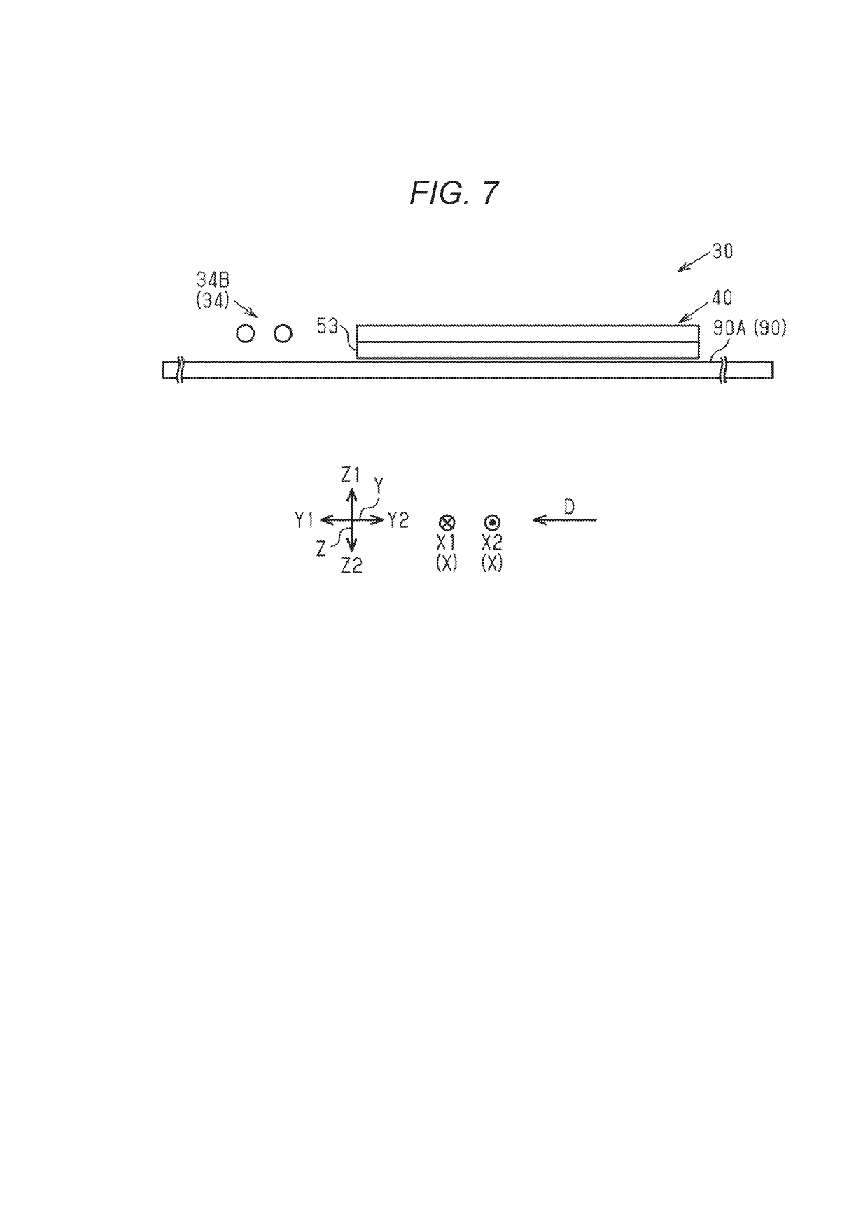

As illustrated in FIG. 7, in the fourth embodiment, the drying unit 30 may include a plurality of first heating sections 34. The drying unit 30 may include two first heating sections 34. The first heating section 34 may be an infrared heater 34B.

The plurality of first heating sections 34 are disposed side by side in the intersecting direction Y. That is, the plurality of first heating sections 34 are provided on the upstream side in the conveyance direction D and the downstream side in the conveyance direction D. The plurality of first heating sections 34 are disposed further in the upward direction Z1 than the medium 90. The drying unit 30 may not include the first contact section 51 and the second contact section 52. The drying unit 30 may not include the fourth contact section 54.

### Modifications

The present embodiment can be implemented by being changed as explained below. The present embodiment and modifications explained below can be implemented in combination with each other as long as no technical inconsistencies are involved.

In the first to third embodiments, the first heating section 34 may be the infrared heater 34B. In the fourth embodiment, the first heating section 34 may be the heating wire heater 34A. That is, the first heating section 34 may heat the medium 90 with a heating wire or an infrared ray.

In the third embodiment, the second electrode 42 may be provided integrally with the conductor housing 80. The drying device 12 may not include the second electrode 42 if the conductor housing 80 is grounded. The conductor housing 80 may function as the second electrode 42.

The drying device 12 may not include the first contact section 51. The drying device 12 may not include the second contact section 52. That is, the drying device 12 may not include at least one of the first contact section 51 and the second contact section 52. As explained above, the medium 90 may not be sandwiched by the first contact section 51 and the second contact section 52.

The drying device 12 may not include the third contact section 53. The drying device 12 may not include the fourth contact section 54. That is, the drying device 12 may not include at least one of the third contact section 53 and the fourth contact section 54. As explained above, the medium 90 may not be sandwiched by the third contact section 53 and the fourth contact section 54.

The drying device 12 may include one or three or more first heating sections 34. For example, in the fourth embodiment, the first heating section 34 disposed upstream in the conveyance direction D may output a larger amount of heat than the first heating section 34 disposed downstream in the conveyance direction D. The first heating section 34 disposed downstream in the conveyance direction D may output a larger amount of heat than the first heating section 34 disposed upstream in the conveyance direction D.

The drying device 12 may include a plurality of temperature detection sections 55. The drying device 12 may include the temperature detection section 55 that detects the temperature of the first contact section 51 and the temperature detection section 55 that detects the temperature of the second contact section 52. The control section 50 may perform control based on the temperature of the first contact section 51 and the temperature of the second contact section 52. As explained above, the temperature detection section 55 may detect the temperature of at least one of the first contact section 51 and the second contact section 52.

The drying device 12 may include the temperature detection section 55 that detects the temperature of the third contact section 53 and the temperature detection section 55 that detects the temperature of the fourth contact section 54. The control section 50 may perform control based on the temperature of the third contact section 53 and the temperature of the fourth contact section 54. As explained above, the temperature detection section 55 may detect the temperature of at least one of the third contact section 53 and the fourth contact section 54. The drying device 12 may not include the temperature detection section 55.

The first heating section 34 may not heat the medium 90 from the rear surface 90B side of the medium 90 and may heat the medium 90 from the front surface 90A side of the medium 90. The first heating section 34 may be disposed in the upward direction Z1 of the medium 90.

The plurality of second heating sections 40 may be disposed such that the width direction X is longitudinal. In this case, the first electrode 41 may be disposed to extend in the width direction X. The plurality of second heating sections 40 may be respectively disposed to incline with respect to the width direction X and the intersecting direction Y.

The plurality of second heating sections 40 are integrally configured by sharing the second electrode 42 but may not share the second electrode 42. The plurality of second heating sections 40 may be respectively configured as separate bodies. The drying unit 30 may include a plurality of second heating sections 40 disposed side by side in one row or a plurality of rows in the width direction X. The drying unit 30 may include a plurality of second heating sections 40 disposed side by side in one row or a plurality of rows in the intersecting direction Y.

The second heating section 40 may heat the medium 90 from the rear surface 90B side of the medium 90. The second heating section 40 may heat the medium 90 from both of the front surface 90A side of the medium 90 and the rear surface 90B side of the medium 90. The second heating section 40 may be capable of performing scanning in the width direction X. The second heating section 40 may be disposed in the downward direction Z2 of the medium 90.

The first electrode 41 is not limited to the flat plate shape and may have, for example, a substantially flat plate shape. The substantially flat plate shape has, for example, an extremely large aspect ratio of a shape curved in a thickness direction, which is a direction along the vertical direction Z, or a rectangular shape and may include a linear shape.

The second electrode 42 is not limited to the flat plate shape and may have, for example, a substantially flat plate shape. The substantially flat plate shape has, for example, an extremely large aspect ratio of a shape curved in a thickness direction, which is a direction in the vertical direction Z, or a rectangular shape and may include a linear shape.

At least one of the first electrode surface 41A and the second electrode surface 42A is not limited to a planar shape and may have a substantially planar shape. The substantially planar shape has, for example, an extremely large aspect ratio of a shape curved in the thickness direction, which is the direction in the vertical direction Z, or a rectangular shape and may include a linear shape.

At least one of the first heating section 34 and the second heating section 40 may not be provided in the drying device 12 and may be provided in the recording device 11. That is, the recording device 11 may include the first heating section 34 and the second heating section 40. In this case, the first heating section 34 and the second heating section 40 may be provided on the downstream side in the conveyance direction D of the recording section 20. As explained above, the first heating section 34 and the second heating section 40 may be applied to the recording device 11 rather than the drying device 12.

A lateral printer may be adopted as the recording device 11. The lateral printer is a printer in which the carriage 25 is movable in both of a main scanning direction and a sub scanning direction.

The medium 90 is not limited to the roll body. The medium 90 may be paper, a film or a sheet made of resin, a composite film of resin and metal, a laminate film, a woven fabric, a nonwoven fabric, a metal foil, a metal film, a ceramic sheet, clothing, or the like.

The liquid can be optionally selected if the liquid can perform recording on the medium 90 by adhering to the medium 90. The liquid may be dye ink such as disperse dye ink or reactive dye ink. For example, the ink includes ink in which particles of a functional material including a solid matter such as pigment or metal particles are dissolved, dispersed, or mixed in a solvent and includes various compositions such as aqueous ink, oil-based ink, gel ink, and hot melt ink.

The expression "at least any one of" used in the present specification means one or more of desired choices. As an example, when the number of choices is two, the expression "at least any one of" used in the present specification means only one choice or both of the two choices. As another example, when the number of choices is three or more, the expression "at least any one of" used in the present specification means only one choice or any combination of two or more choices.

### Appendices

Technical ideas figured out from the embodiments and the modifications explained above and action effects thereof are explained below. The technical ideas and the action effects thereof can be combined with each other within a range where no technical contradictions are involved.

[1] A drying device including: a conveyance section configured to convey a medium onto which liquid is ejected; a first heating section configured to heat the medium conveyed by the conveyance section; and a second heating section provided further upstream in a conveyance direction of the medium than the first heating section and configured to heat the medium conveyed by the conveyance section, wherein the first heating section heats the medium with an infrared ray or a heating wire, and the second heating section includes: a first electrode; a second electrode disposed to surround the first electrode in plan view from a first direction facing the medium; a first conductor including a coil and configured to electrically couple a transmission line capable of transmitting a high-frequency voltage and the first electrode; and a second conductor configured to electrically couple the transmission line and the second electrode.

With this configuration, the first heating section that heats the medium by the infrared ray or the heating wire is provided further downstream in the conveyance direction than the second heating section that generates electromagnetic waves. Accordingly, it is possible to increase, with the electromagnetic waves generated from the second heating section, the speed of raising the temperature of the liquid ejected onto the medium. In addition, after the temperature of the liquid ejected onto the medium is raised, it is possible to easily perform, with heat from the first heating section, temperature adjustment for the medium onto which the liquid has been ejected. Accordingly, it is possible to suppress occurrence of thermal denaturation on the medium. Therefore, it is possible to dry the medium while maintaining the quality of the medium.

[2] The drying device may include: a first contact section provided between the first heating section and the medium and configured to come into contact with the medium; and a second contact section provided at a position where the medium is sandwiched between the second contact section and the first contact section and configured to come into contact with the medium.

With this configuration, the medium can be dried by the heat from the first heating section in a state in which the medium is in contact with the first contact section and the second contact section between the first contact section and the second contact section. That is, the medium can be dried in a state of being sandwiched by the first contact section and the second contact section. Accordingly, it is possible to suppress shrinkage of the medium involved in the heating of the medium. For this reason, it is possible to suppress occurrence of thermal denaturation on the medium. Therefore, it is possible to dry the medium while maintaining the quality of the medium.

[3] The drying device may further include a temperature detection section configured to detect a temperature of at least one of the first contact section and the second contact section, and the first heating section may be controlled based on a detection result by the temperature detection section.

With this configuration, the first heating section can be controlled according to the temperature of at least one of the first contact section and the second contact section. Therefore, after the temperature of the liquid ejected onto the medium is raised, temperature adjustment for the medium onto which the liquid has been ejected can be easily performed by the heat from the first heating section. Accordingly, it is possible to suppress occurrence of thermal denaturation on the medium. Therefore, it is possible to dry the medium while maintaining the quality of the medium.

[4] The drying device may include: a third contact section provided between the second heating section and the medium and configured to come into contact with the medium; and a fourth contact section provided at a position where the medium is sandwiched between the fourth contact section and the third contact section and configured to come into contact with the medium.

With this configuration, the medium can be dried by the electromagnetic waves from the second heating section in a state in which the medium is in contact with the third contact section and the fourth contact section. When the liquid ejected onto the medium is vaporized, vaporized moisture stays in the vicinity of the medium. Accordingly, it is possible to reduce a difference in a calorific value of the liquid due to a type of the medium and a type of the liquid. In addition, since it is possible to improve the airtightness between the third contact section and the fourth contact section and the medium, it is possible to dry the medium in an environment in which the liquid is less likely to oxidize. It is possible to suppress an imbalance in the distance between the medium and the second heating section. It is possible to suppress shrinkage of the medium involved in heating of the medium. For this reason, it is possible to suppress occurrence of thermal denaturation on the medium. Therefore, it is possible to dry the medium while maintaining the quality of the medium.

[5] The drying device may include a first contact section provided between the first heating section and the medium and configured to come into contact with the medium, a heating region by the first heating section and a heating region by the second heating section in the conveyance direction of the medium may partially overlap, and the first contact section may be heated by the second heating section.

With this configuration, the temperature of the medium can be sufficiently raised by heating from both the first heating section and the second heating section. Therefore, it is possible to improve the drying efficiency of the medium.

[6] In the drying device, the first contact section may contain ceramic.

With this configuration, by using a material having a high thermal conductivity for the first contact section, it is easy to maintain temperature for the medium by the first heating section and the second heating section. Accordingly, it is possible to suppress occurrence of thermal denaturation on the medium. Therefore, it is possible to dry the medium while maintaining the quality of the medium.

[7] In the drying device, the first heating section and the second heating section may be provided to be separated in the conveyance direction of the medium.

With this configuration, influence between the first heating section and the second heating section can be reduced. Accordingly, it is possible to perform heating by the first heating section and heating by the second heating section as intended.

[8] In the drying device, the liquid may be pigment ink containing pigment, water, and a solvent.

With this configuration, temporary drying in which the water is vaporized from the liquid ejected onto the medium can be performed by the second heating section. Accordingly, it is possible to increase, with the electromagnetic waves generated from the second heating section, the speed of vaporizing the water from the liquid ejected onto the medium. In addition, it is possible to perform, with the first heating section, main drying in which the solvent is vaporized from the liquid ejected onto the medium. As explained above, it is possible to easily perform, with the heat from the first heating section, temperature adjustment for the medium onto which the liquid has been ejected. Accordingly, it is possible to suppress occurrence of thermal denaturation on the medium. Therefore, it is possible to dry the medium while maintaining the quality of the medium.

[9] A recording device including: a recording section configured to perform recording by ejecting liquid onto a medium; a conveyance section configured to convey the medium onto which the liquid is ejected by the recording section; a first heating section configured to heat the medium conveyed by the conveyance section; and a second heating section provided further upstream in a conveyance direction of the medium than the first heating section and configured to heat the medium conveyed by the conveyance section, wherein the first heating section heats the medium with an infrared ray or a heating wire, and the second heating section includes: a first electrode; a second electrode disposed to surround the first electrode in plan view from a first direction facing the medium; a first conductor including a coil and configured to electrically couple a transmission line capable of transmitting a high-frequency voltage and the first electrode; and a second conductor configured to electrically couple the transmission line and the second electrode. With this configuration, it is possible to achieve the same effects as the effects in [1].

What is claimed is:

1. A drying device comprising:
a conveyance section configured to convey a medium onto which liquid is ejected;
a first heating section configured to heat the medium conveyed by the conveyance section; and
a second heating section provided further upstream in a conveyance direction of the medium than the first heating section and configured to heat the medium conveyed by the conveyance section, wherein
the first heating section heats the medium with an infrared ray or a heating wire, and
the second heating section includes:
a first electrode;
a second electrode disposed to surround the first electrode in plan view from a first direction facing the medium;
a first conductor including a coil and configured to electrically couple a transmission line capable of transmitting a high-frequency voltage and the first electrode; and
a second conductor configured to electrically couple the transmission line and the second electrode.

2. The drying device according to claim 1, further comprising:
a first contact section provided between the first heating section and the medium and configured to come into contact with the medium; and
a second contact section provided at a position where the medium is sandwiched between the second contact section and the first contact section and configured to come into contact with the medium.

3. The drying device according to claim 2, further comprising a temperature detection section configured to detect a temperature of at least one of the first contact section and the second contact section, wherein
the first heating section is controlled based on a detection result by the temperature detection section.

4. The drying device according to claim 3, further comprising:
a third contact section provided between the second heating section and the medium and configured to come into contact with the medium; and
a fourth contact section provided at a position where the medium is sandwiched between the fourth contact section and the third contact section and configured to come into contact with the medium.

5. The drying device according to claim 1, further comprising a first contact section provided between the first heating section and the medium and configured to come into contact with the medium, wherein
a heating region by the first heating section and a heating region by the second heating section in the conveyance direction of the medium partially overlap, and
the first contact section is heated by the second heating section.

6. The drying device according to claim 5, wherein the first contact section contains ceramic.

7. The drying device according to claim 1, wherein the first heating section and the second heating section are provided to be separated in the conveyance direction of the medium.

8. The drying device according to claim 1, wherein the liquid is pigment ink containing pigment, water, and a solvent.

9. A recording device comprising:
a recording section configured to perform recording by ejecting liquid onto a medium;
a conveyance section configured to convey the medium onto which the liquid is ejected by the recording section;
a first heating section configured to heat the medium conveyed by the conveyance section; and
a second heating section provided further upstream in a conveyance direction of the medium than the first heating section and configured to heat the medium conveyed by the conveyance section, wherein
the first heating section heats the medium with an infrared ray or a heating wire, and
the second heating section includes:
a first electrode;
a second electrode disposed to surround the first electrode in plan view from a first direction facing the medium;
a first conductor including a coil and configured to electrically couple a transmission line capable of transmitting a high-frequency voltage and the first electrode; and
a second conductor configured to electrically couple the transmission line and the second electrode.
